(19) United States
(12) Patent Application Publication
(10) Pub. No.: US 2026/0322018 A1
(43) Pub. Date: Oct. 15, 2026

(54) CABLE-END CONNECTOR AND METHOD FOR ASSEMBLING THE SAME

(71) Applicant: Bellwether Electronic Corp., Taoyuan City (TW)

(72) Inventor: Chia-Yi CHANG, Taoyuan City (TW)

(21) Appl. No.: 19/578,900

(22) Filed: Mar. 26, 2026

Related U.S. Application Data
(60) Provisional application No. 63/788,832, filed on Apr. 15, 2025.

(30) Foreign Application Priority Data
Feb. 12, 2026 (TW) 115105629

(51) Int. Cl. H01R 13/02; H01R 13/436; H01R 13/50; H01R 13/627

(52) U.S. Cl. CPC H01R 13/025; H01R 13/4361; H01R 13/50; H01R 13/6272

(57) ABSTRACT

A cable-end connector includes an insulating housing, a plurality of terminals and an isolating structure. The insulating housing has a first opening and a plurality of second openings opposite to the first opening. The terminals are at least partially located inside the insulating housing. Each of the terminals includes a wiring section and a mating section. The wiring section is at least partially exposed from the first opening. The wiring section has a first thickness. The mating section is connected to the wiring section and at least partially exposed from the second openings. The mating section has a second thickness greater than the first thickness. The isolating structure is sandwiched between the terminals.

### RELATED APPLICATIONS

This application claims priority to U.S. Provisional Application Serial Number 63/788,832 filed Apr. 15, 2025, and Taiwan Application Serial Number 115105629, filed Feb. 12, 2026, the disclosures of which are incorporated herein by reference in their entireties.

### BACKGROUND

### Technical Field

The present disclosure relates to cable-end connectors and methods for assembling a cable-end connector, and more particularly to cable-end connectors capable of transmitting large current.

### Description of Related Art

As the pace of modern life continues to accelerate, the demand for electronic devices has been steadily increasing. Facing to a huge consumer market, major manufacturers strive to enhance the functionality and performance of their products in order to boost the market competitiveness of their products.

Taking power connectors as an example, the measure to allow a higher current to flow in a safe manner, is undoubtedly an important issue that the industry highly concerns about and also a goal that needs urgent improvement in the related field.

### SUMMARY

A technical aspect of the present disclosure is to provide a cable-end connector, which can effectively increase the allowable current capacity.

According to an embodiment of the present disclosure, a cable-end connector includes an insulating housing, a plurality of terminals and an isolating structure. The insulating housing has a first opening and a plurality of second openings opposite to the first opening. The terminals are at least partially located inside the insulating housing. Each of the terminals includes a wiring section and a mating section. The wiring section is at least partially exposed from the first opening. The wiring section has a first thickness. The mating section is connected to the wiring section and at least partially exposed from the second openings. The mating section has a second thickness greater than the first thickness. The isolating structure is sandwiched between the terminals.

Another technical aspect of the present disclosure is to provide a method for assembling a cable-end connector, which can assemble a cable-end connector capable of effectively increasing the allowable current capacity.

According to an embodiment of the present disclosure, a method for assembling a cable-end connector includes: providing at least one first terminal element, the first terminal element comprising a wiring section, a first body and a plurality of first conductive arms, the first body being connected between the wiring section and the first conductive arms; connecting at least one wire to the wiring section; providing at least one second terminal element, the second terminal element comprising a connected second body and a plurality of second conductive arms connected with the second body; stacking and fixing the second terminal element on the first terminal element to form a terminal, the second body being aligned with the first body, the second conductive arms being aligned with the first conductive arms; connecting a plurality of the terminals formed to two opposite sides of an isolating structure respectively to form a terminal assembly; at least partially overmolding the terminal assembly with an inner mold; providing an insulating housing having a first opening and a plurality of second openings opposite to the first opening; inserting the terminal assembly into the insulating housing through the first opening such that the first conductive arms and the second conductive arms are at least partially exposed from the second openings; inserting a terminal position assurance member at least partially through the insulating housing and the isolating structure, and latching the terminal position assurance member at least partially with an outer side of the insulating housing; and at least partially overmolding the insulating housing and the terminal assembly with an outer mold. The wiring section has a first thickness. The first conductive arms and the second conductive arms together define a second thickness greater than the first thickness.

### BRIEF DESCRIPTION OF THE DRAWINGS

The disclosure can be more fully understood by reading the following detailed description of the embodiments, with reference made to the accompanying drawings as follows:

FIG. 1 is a perspective view of a cable-end connector according to an embodiment of the present disclosure;

FIG. 2 is a cross-sectional view along the sectional line A-A of FIG. 1;

FIG. 3 is a perspective view of the cable-end connector of FIG. 1, in which the terminal assembly and the insulating housing are separated from each other, with the wires omitted;

FIG. 4 is an exploded view of the terminal assembly of FIG. 3;

FIG. 5 is a top view of the first terminal piece/second terminal piece of FIG. 4;

FIG. 6 is a perspective view of the terminal position assurance member of FIG. 3;

FIG. 7 is a partial cross-sectional view of the cable-end connector of FIG. 1, in which the terminal position assurance member is latched to the insulating housing;

FIG. 8 is a perspective view of the cable-end connector of FIG. 1, in which the outer mold at least partially encloses the junction between the terminal assembly and the insulating housing;

FIG. 9 is a flowchart of a method for assembling a cable-end connector according to an embodiment of the present disclosure;

FIG. 10 is a perspective view of the cable-end connector of FIG. 1 from another viewing angle;

FIG. 11 is a perspective view showing the internal structure of the insulating housing of FIG. 10;

FIG. 12 is a cross-sectional view along the sectional line B-B of FIG. 10;

FIG. 13 is a cross-sectional view along the sectional line C-C of FIG. 10;

FIG. 14 is a top view of a terminal according to another embodiment of the present disclosure; and

FIG. 15 is a top view of a terminal according to a further embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

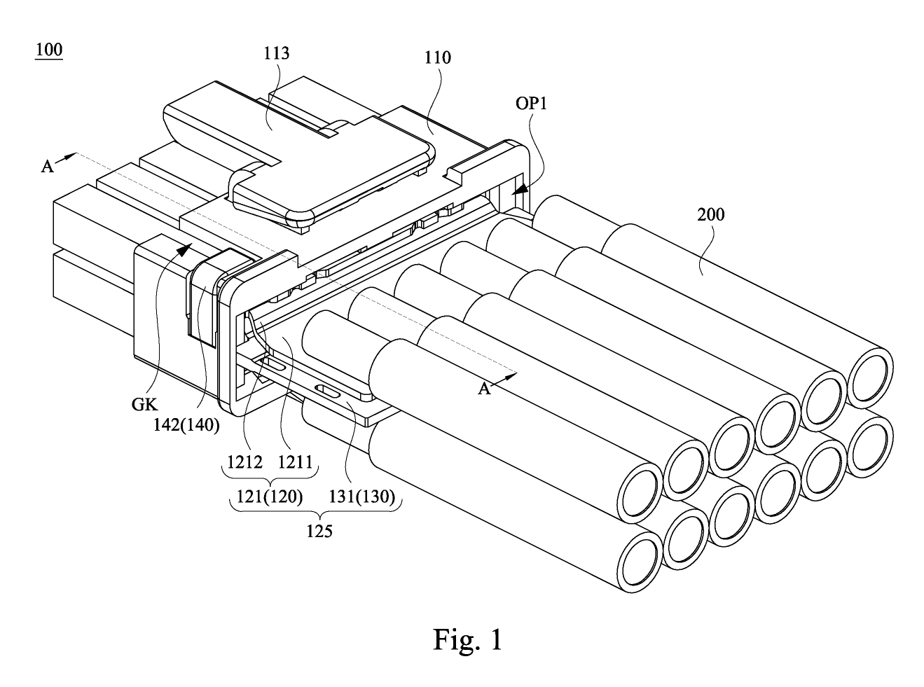

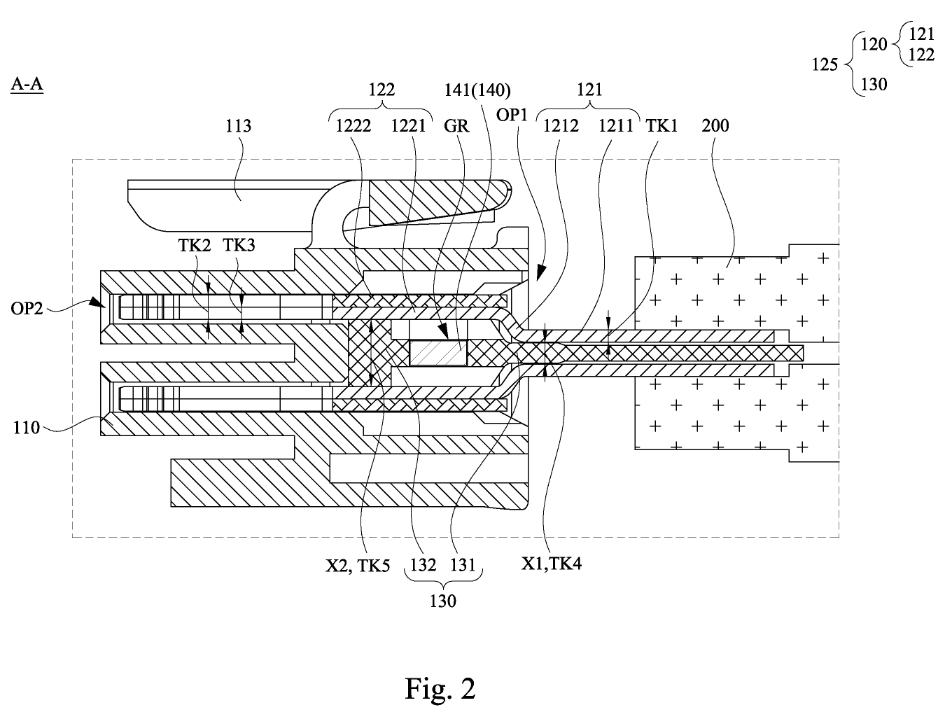

Please refer to FIGS. 1-2. In this embodiment, as shown in FIGS. 1-2, a cable-end connector 100 includes an insulating housing 110 and a terminal assembly 125, in which the terminal assembly 125 includes a plurality of terminals 120 and an isolating structure 130. The insulating housing 110 has a first opening OP1 and a plurality of second openings OP2. The second openings OP2 are opposite to the first opening OP1, i.e., the second openings OP2 and the first opening OP1 are located on two opposite sides of the insulating housing 110. The terminals 120 are at least partially located inside the insulating housing 110, and each of the terminals 120 includes a wiring section 121 and a mating section 122. The wiring section 121 is at least partially exposed from the first opening OP1 and is configured to connect with at least one wire 200. The wire 200 can practically be a cable or an electric wire. In other embodiments, the wire 200 can also be a busbar. The mating section 122 is connected with the wiring section 121 and is at least partially exposed from the second openings OP2. When the cable-end connector 100 is mated with another connector (not shown), the insulating housing 110 abuts against the other connector, and the mating section 122 is electrically connected with terminals of the other connector. In practice, the insulating housing 110 is further disposed with a latch member 113 for latching onto the other connector when the cable-end connector 100 is mated with the other connector, thereby enhancing the stability of the mating. The isolating structure 130 is sandwiched between the terminals 120 so as to electrically insulate the terminals 120 from each another. Furthermore, the wiring section 121 has a first thickness TK1, while the mating section 122 has a second thickness TK2. It is worth to note that, the second thickness TK2 of the mating section 122 is greater than the first thickness TK1 of the wiring section 121, which can effectively increase the allowable current capacity of the terminal 120, as detailed below.

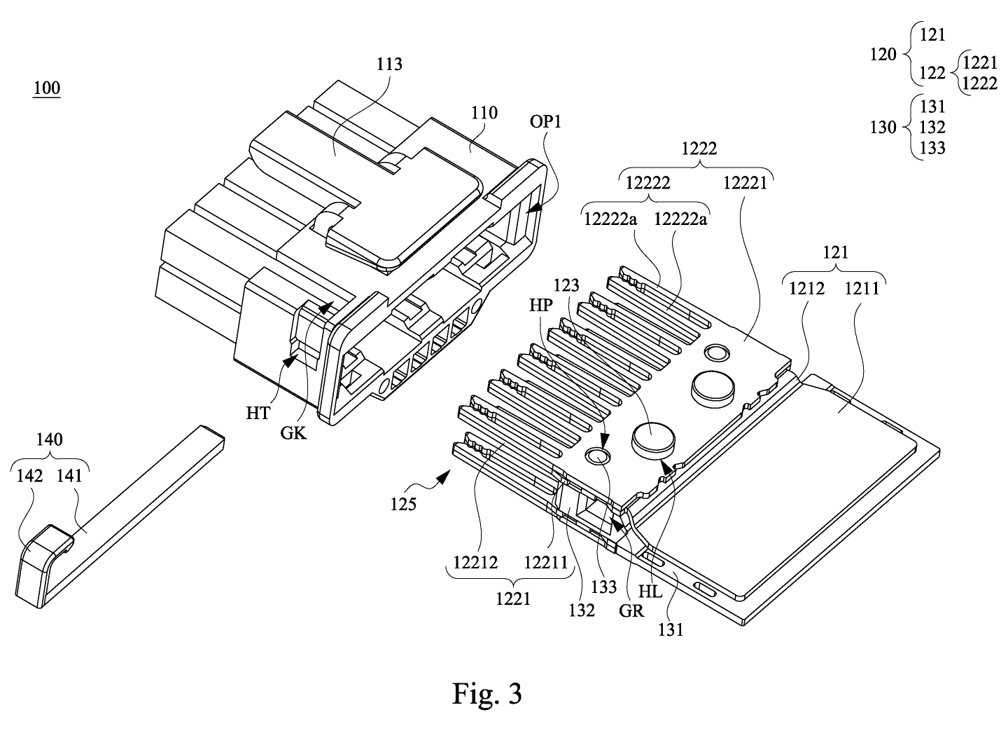

Please refer to FIGS. 2-4. The mating section 122 of the terminal 120 includes a first terminal piece 1221 and a second terminal piece 1222. The first terminal piece 1221 is connected with the wiring section 121 and at least partially abuts against the isolating structure 130. The first terminal piece 1221 has a third thickness TK3, and the third thickness TK3 is equal to the first thickness TK1 of the wiring section 121. In practice, the first terminal piece 1221 and the wiring section 121 are integrally formed. The second terminal piece 1222 is stacked on a side of the first terminal piece 1221 facing away from the isolating structure 130, such that the overall thickness of the mating section 122, i.e., the second thickness TK2, is greater than the first thickness TK1 of the wiring section 121. Depending on actual situations, more than one second terminal piece 1222 may be stacked on the first terminal piece 1221, for example, two pieces, three pieces, or more.

Specifically, the first terminal piece 1221 includes a first body 12211 and a plurality of first terminal portions 12212. The first body 12211 is connected with the wiring section 121, and the first terminal portions 12212 are respectively connected with the first body 12211. Each of the first terminal portions 12212 includes a pair of first conductive arms 12212a, and the first conductive arms 12212a are at least partially exposed from a corresponding one of the second openings OP2 respectively. Similarly, the second terminal piece 1222 includes a second body 12221 and a plurality of second terminal portions 12222. The second body 12221 is stacked on the first body 12211 of the first terminal piece 1221, and the second terminal portions 12222 are respectively connected with the second body 12221. Each of the second terminal portions 12222 includes a pair of second conductive arms 12222a. The second conductive arms 12222a are aligned with and stacked on the first conductive arms 12212a, and the second conductive arms 12222a are at least partially exposed from a corresponding one of the second openings OP2 respectively. In other words, a portion of the mating section 122 is formed by stacking the first conductive arms 12212a of the first terminal piece 1221 and the second conductive arms 12222a of the second terminal piece 1222. In practice, a quantity of the first terminal portions 12212 is equal to a quantity of the second terminal portions 12222. Thus, a quantity of the first conductive arms 12212a is also equal to a quantity of the second conductive arms 12222a.

Although the first conductive arms 12212a and the second conductive arms 12222a are each substantially elongated and have a relatively small cross-sectional area with respect to the first body 12211 and the second body 12221, as described above, since the second thickness TK2 of the mating section 122 is greater than the first thickness TK1 of the wiring section 121, the cross-sectional area of the terminal 120 at the mating section 122 can be maintained even though a portion of the mating section 122 is formed by stacking the first conductive arms 12212a and the second conductive arms 12222a. This is advantageous for increasing the allowable current capacity of the terminal 120.

On the other hand, the wiring section 121 of the terminal 120 includes a connecting portion 1211 and a bent portion 1212. In practice, both the connecting portion 1211 and the bent portion 1212 have the first thickness TK1. The connecting portion 1211 abuts against the isolating structure 130 and is configured to connect with the wire 200 aforementioned. The connection between the connecting portion 1211 and the wire 200 may be achieved by welding, for example, ultrasonic welding. The bent portion 1212 is connected between the connecting portion 1211 and the first terminal piece 1221, such that there is a height difference in the horizontal level between the connecting portion 1211 and the first terminal piece 1221. As shown in FIG. 2, the connecting portions 1211 define a first distance X1 therebetween, and the first terminal pieces 1221 define a second distance X2 therebetween. In this embodiment, the first distance X1 is smaller than the second distance X2. Therefore, the overall height of the wires 200 connected to the outer side of the connecting portions 1211 can be effectively reduced.

Furthermore, the isolating structure 130 includes an isolating plate 131 and a locking portion 132. The isolating plate 131 is sandwiched between the wiring sections 121, and the locking portion 132 is connected with the isolating plate 131 and is at least partially sandwiched between the first terminal pieces 1221. Moreover, the isolating plate 131 has a fourth thickness TK4, while the locking portion 132 has a fifth thickness TK5. The fifth thickness TK5 of the locking portion 132 is greater than the fourth thickness TK4 of the isolating plate 131. In practice, the fourth thickness TK4 is equal to the first distance X1 between the connecting portions 1211, and the fifth thickness TK5 is equal to the second distance X2 between the first terminal pieces 1221.

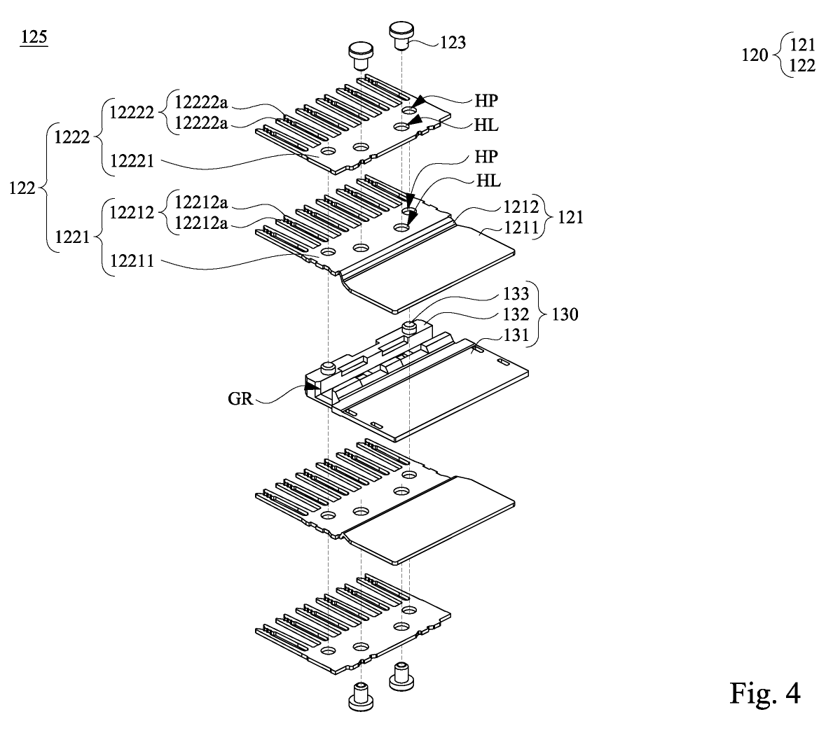

In practical applications, as shown in FIG. 4, the first body 12211 and the second body 12221 each have a plurality of locking holes HL, and the terminal assembly 125 further includes a plurality of fasteners 123. The fasteners 123 are configured to be fastened into the locking holes HL of the first body 12211 and the second body 12221, so as to fix the relative positions of the first terminal piece 1221 and the second terminal piece 1222. The fasteners 123 may be, for example, rivets or screws. In other embodiments, the first terminal piece 1221 and the second terminal piece 1222 may be connected by welding, for example, ultrasonic welding.

Furthermore, the isolating structure 130 further includes a plurality of positioning portions 133. The positioning portions 133 are disposed on the locking portion 132. Correspondingly, the first body 12211 and the second body 12221 further have a plurality of positioning holes HP respectively. The positioning portions 133 are configured to pass through the positioning holes HP of the first body 12211 and the second body 12221, so as to restrict the relative positions therebetween.

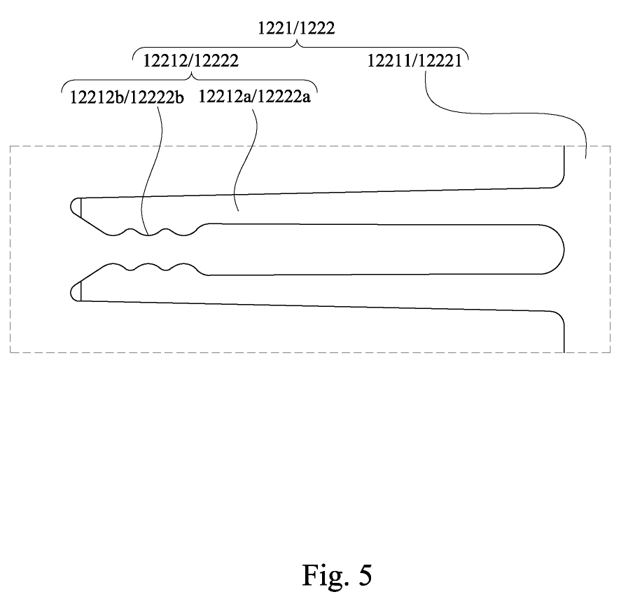

Please refer to FIG. 5. Each of the first terminal portions 12212 further includes at least one first protrusion 12212b. The first protrusion 12212b is located on a side of one of the first conductive arms 12212a facing to the other one of the first conductive arms 12212a, i.e., the first protrusion 12212b is disposed on the inner side of the first conductive arms 12212a. When a terminal of another connector is mated with the first terminal portion 12212, the terminal of the other connector is inserted between the first conductive arms 12212a. During this process, the first protrusion 12212b can abut and rub against the surface of the terminal of the other connector, thereby preventing particles such as contaminants on the terminal of the other connector from being carried into the interior of the cable-end connector 100 and affecting the performance of the cable-end connector 100.

Depending on actual situations, for example, considering the magnitude of the pressure exerted by the first protrusion 12212b on the terminal of the other connector when the terminal is inserted between the first conductive arms 12212a, the first protrusions 12212b on each pair of first conductive arms 12212a may be aligned with each other or offset from each other, or the first protrusion 12212b may be disposed on only one of the first conductive arms 12212a and not on the other one of the first conductive arms 12212a. For example, as shown in FIG. 5, three first protrusions 12212b are respectively disposed on each of the first conductive arms 12212a, and the first protrusions 12212b located on different first conductive arms 12212a are aligned with one another.

Similarly, as shown in FIG. 5, each of the second terminal portions 12222 further includes at least one second protrusion 12222b. The second protrusion 12222b is located on a side of one of the second conductive arms 12222a facing to the other one of the second conductive arms 12222a, i.e., the second protrusion 12222b is disposed on the inner side of the second conductive arms 12222a. The arrangement and function of the second protrusions 12222b are the same as those of the first protrusions 12212b and will not be repeated herein.

Depending on actual situations, for example, considering the magnitude of the pressure exerted by the first protrusions 12212b and the second protrusions 12222b on the terminal of the other connector when the terminal is inserted between the first conductive arms 12212a and the second conductive arms 12222a, the first protrusions 12212b and the second protrusions 12222b may be aligned with each other or offset from each other, or the first protrusions 12212b and the second protrusions 12222b may be disposed on the first conductive arms 12212a and the second conductive arms 12222a at only one side and not the first conductive arms 12212a and the second conductive arms 12222a at the other side.

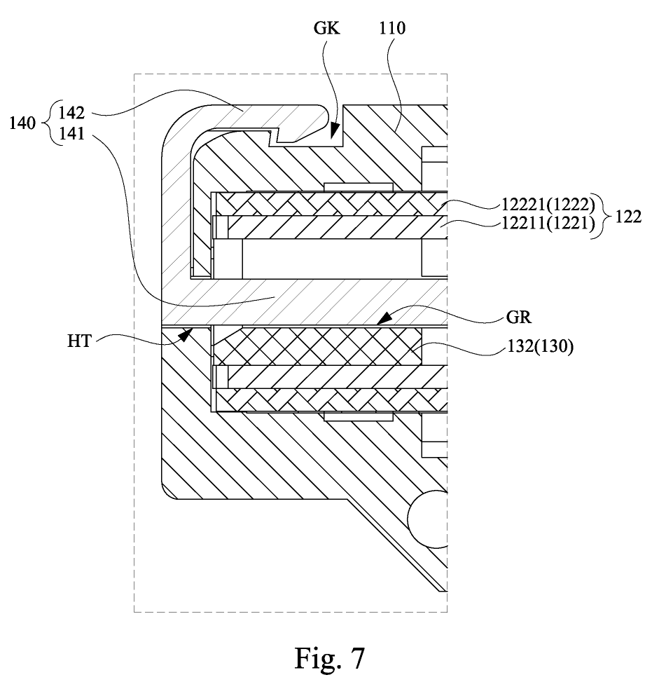

Please refer to FIGS. 1-4 and 6-7. The insulating housing 110 has at least one latch groove GK and at least one through hole HT, and the locking portion 132 of the isolating structure 130 has at least one recess GR. The cable-end connector 100 further includes a terminal position assurance (TPA) member 140. Specifically, the terminal position assurance member 140 includes an insertion rod 141 and a latch portion 142 connected with the insertion rod 141. The insertion rod 141 is configured to be sequentially inserted into the through hole HT of the insulating housing 110 and the recess GR of the isolating structure 130, so as to prevent the terminal assembly 125 from detaching from the insulating housing 110. The latch portion 142 is located outside the insulating housing 110 and is configured to latch into the latch groove GK of the insulating housing 110, so as to prevent the terminal position assurance member 140 from loosening from the insulating housing 110, thereby ensuring that the terminal assembly 125 can be securely connected inside the insulating housing 110.

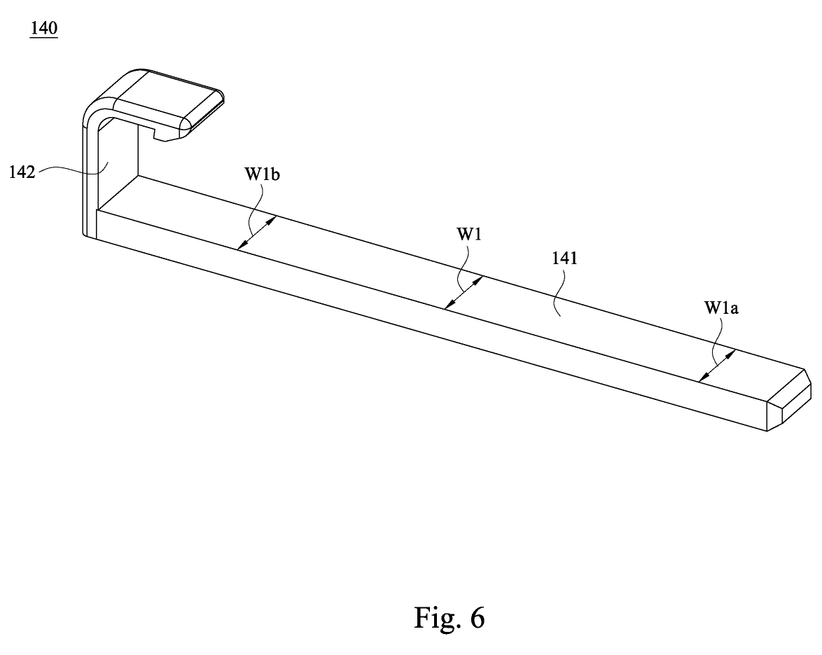

Furthermore, as shown in FIG. 6, the insertion rod 141 of the terminal position assurance member 140 has a first width W1, and the first width W1 gradually decreases in a direction away from the latch portion 142. That is, the width W1a of the insertion rod 141 away from the latch portion 142 is smaller than the width W1b near the latch portion 142, thereby facilitating sequential insertion of the insertion rod 141 into the through hole HT of the insulating housing 110 and the recess GR of the isolating structure 130.

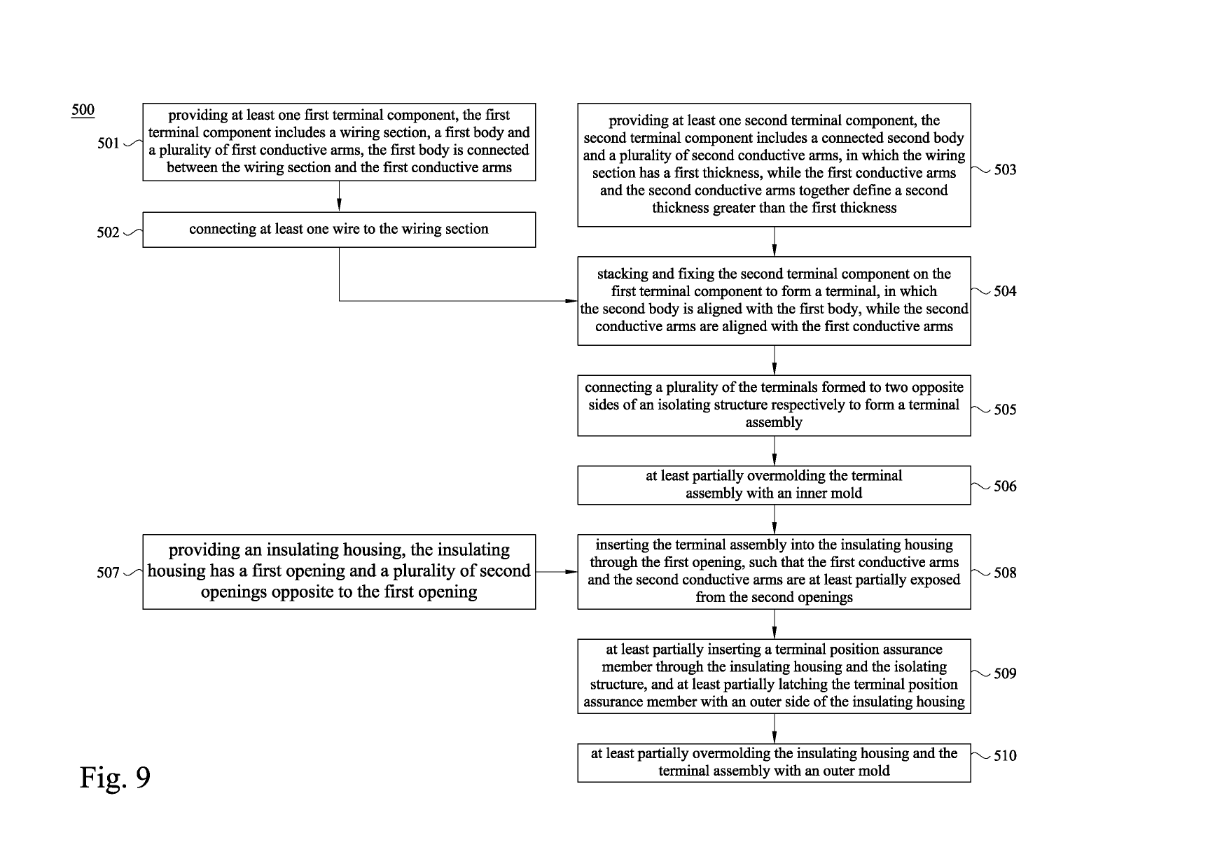

Please refer to FIG. 9. FIG. 9 is a flowchart of a method 500 for assembling a cable-end connector according to an embodiment of the present disclosure. The assembly method 500 includes the following steps, which should be understood that the order of steps mentioned below can be changed as per actual requirements, and some of the steps may be executed simultaneously or partially simultaneously unless their sequence is explicitly stated:

Step 501: providing at least one first terminal component. The first terminal component includes a wiring section 121, a first body 12211 and a plurality of first conductive arms 12212a. The first body 12211 is connected between the wiring section 121 and the first conductive arms 12212a.

Step 502: connecting at least one wire 200 to the wiring section 121, which may be performed by welding, for example, ultrasonic welding.

Step 503: providing at least one second terminal component. The second terminal component includes a connected second body 12221 and a plurality of second conductive arms 12222a. In this embodiment, the wiring section 121 has a first thickness TK1, while the first conductive arms 12212a and the second conductive arms 12222a together define a second thickness TK2. The second thickness TK2 is greater than the first thickness TK1.

Step 504: stacking and fixing the second terminal component on the first terminal component to form a terminal 120, in which the second body 12221 is aligned with the first body 12211, while the second conductive arms 12222a are aligned with the first conductive arms 12212a.

Step 505: connecting a plurality of the terminals 120 formed to two opposite sides of an isolating structure 130 respectively to form a terminal assembly 125.

Step 506: at least partially overmolding the terminal assembly 125 with an inner mold (not shown) to fix the structure of the terminal assembly 125.

Step 507: providing an insulating housing 110. The insulating housing 110 has a first opening OP1 and a plurality of second openings OP2 opposite to the first opening OP1.

Step 508: inserting the terminal assembly 125 into the insulating housing 110 through the first opening OP1, such that the first conductive arms 12212a and the second conductive arms 12222a are at least partially exposed from the second openings OP2.

Step 509: at least partially inserting a terminal position assurance member 140 through the insulating housing 110 and the isolating structure 130, and at least partially latching the terminal position assurance member 140 with an outer side of the insulating housing 110, so as to prevent the terminal assembly 125 from detaching from the insulating housing 110.

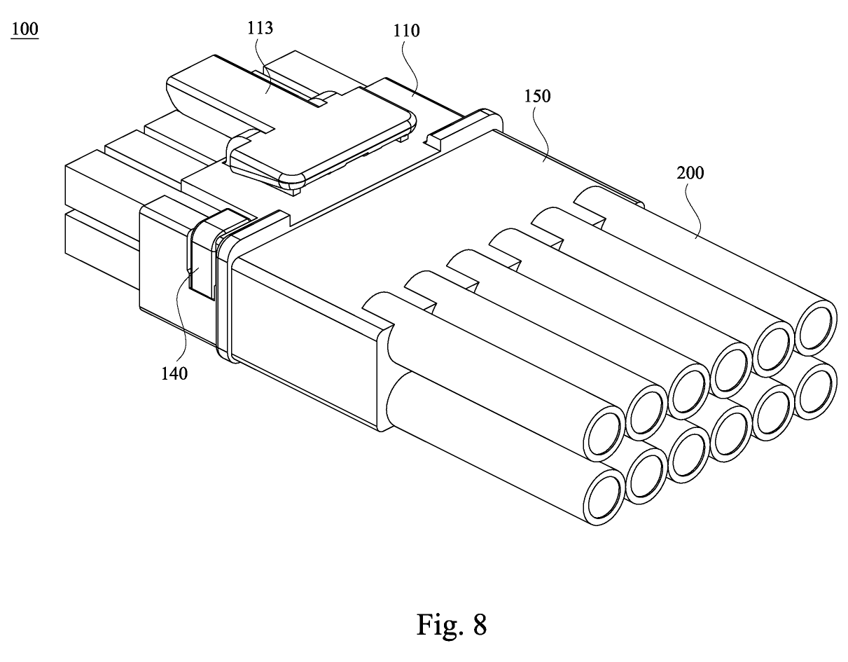

Step 510: at least partially overmolding the junction between the insulating housing 110 and the terminal assembly 125 with an outer mold 150 (as shown in FIG. 8; please refer to FIGS. 1-4 for the terminal assembly 125), so as to provide protection for the cable-end connector 100 formed. In practical applications, the surface of the outer mold 150 may further be covered with acetate cloth (not shown).

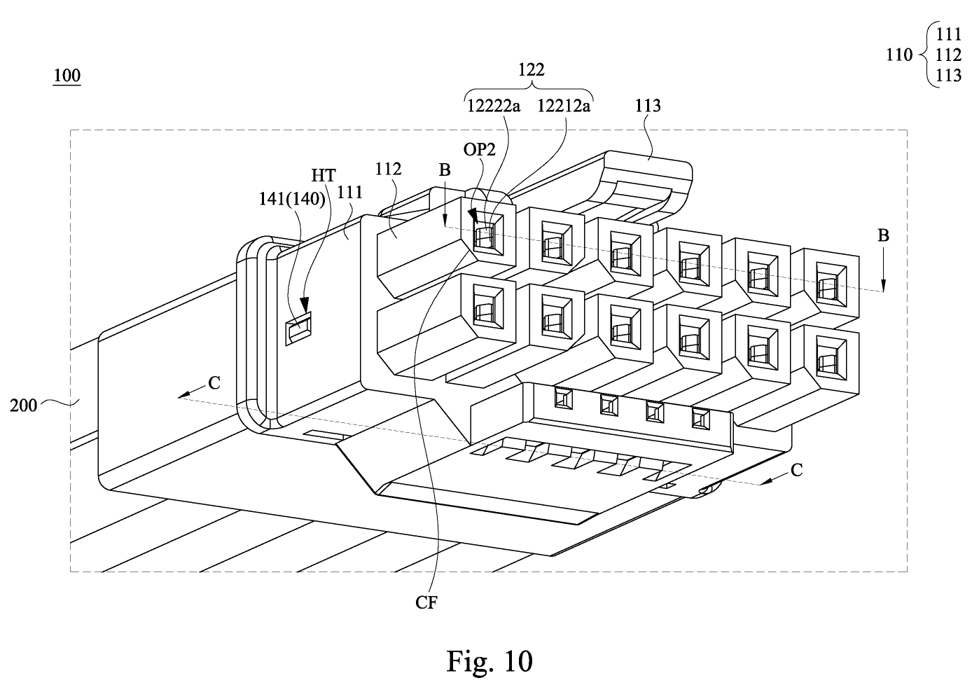

Please refer to FIG. 10. The insulating housing 110 includes a main body portion 111 and a plurality of hollow column portions 112. The through hole HT is located in the main body portion 111. The hollow column portions 112 are spaced apart from one another and are respectively connected with the main body portion 111, and the hollow column portions 112 are configured to connect with another connector. Moreover, the hollow column portions 112 respectively have the second opening OP2 aforementioned, so as to allow a terminal of another connector to be inserted therein and to be at least partially electrically connected with the terminal 120 located in the second openings OP2. For example, the cross-section of at least one of the hollow column portions 112 is rectangular and has at least one chamfer CF, so as to correspond to the shape of the other connector, thereby providing a foolproof function when the cable-end connector 100 is mated with the other connector.

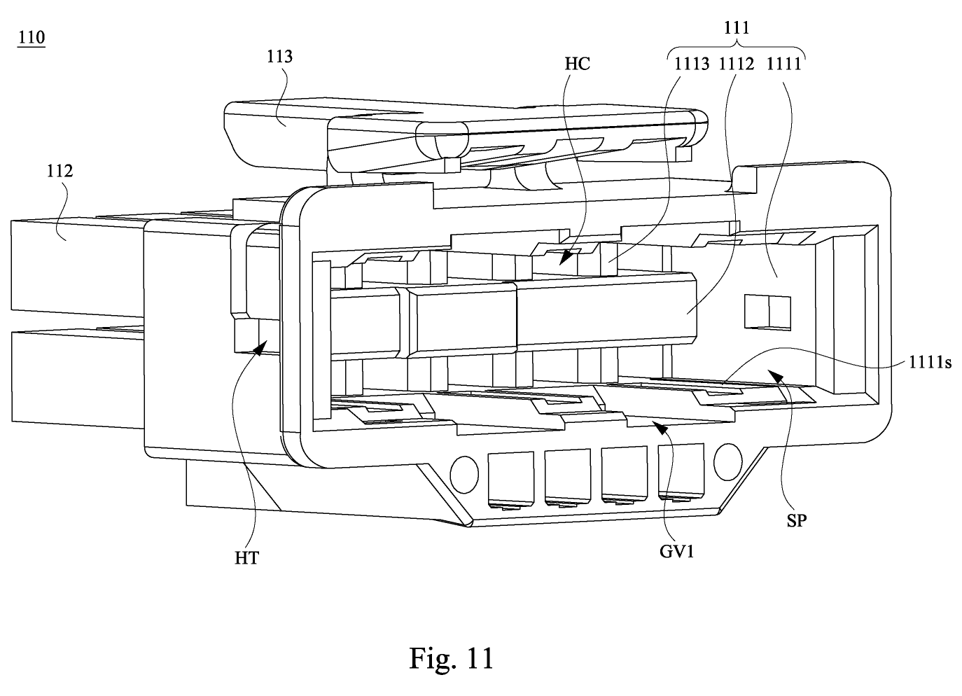

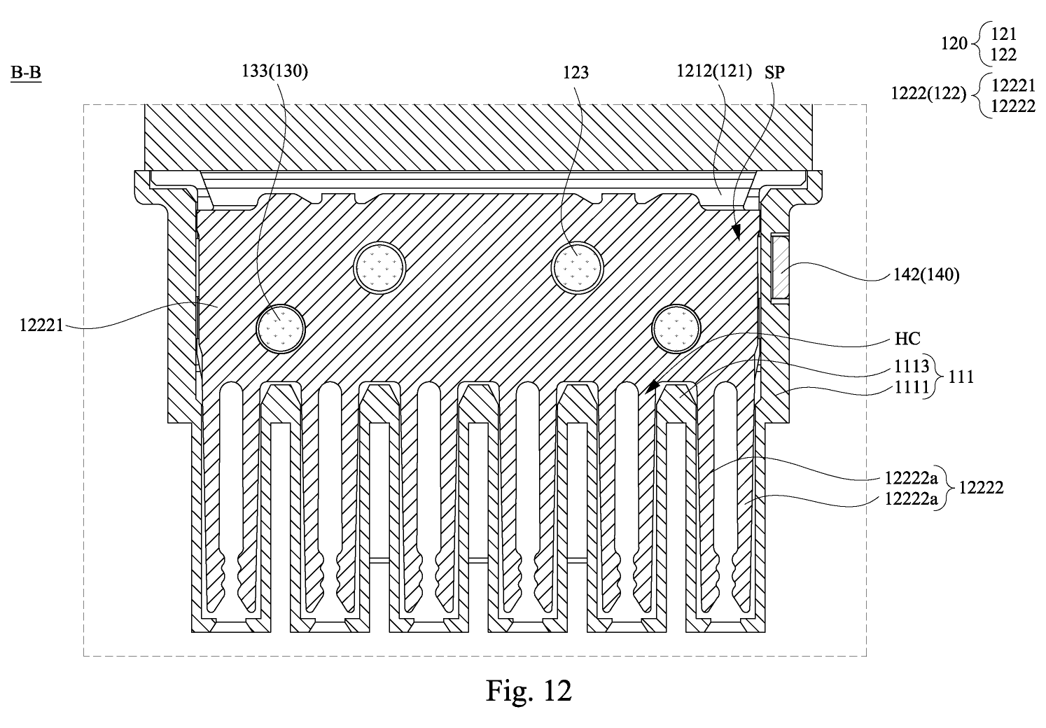

Please refer to FIGS. 11-12. The main body portion 111 of the insulating housing 110 includes an outer shell 1111, an abutting portion 1112 and a plurality of isolating portions 1113. The outer shell 1111 defines a space SP for at least partially receiving the terminal assembly 125. The abutting portion 1112 is connected with the outer shell 1111 and is located in the space SP. The abutting portion 1112 is configured to abut against the locking portion 132 of the isolating structure 130. The isolating portions 1113 are distributed on two opposite sides of the abutting portion 1112 and respectively connected with the outer shell 1111. The isolating portions 1113 are spaced apart from each other to define communication holes HC therebetween. The communication holes HC are communicated with the space SP and communicated with corresponding second openings OP2 through the hollow column portions 112. The first terminal portions 12212 and the second terminal portions 12222 pass through the space SP and are inserted into the communication holes HC, so as to be at least partially exposed from the second openings OP2. The isolating portions 1113 abut against the first body 12211 and the second body 12221, so as to restrict the position of the terminal assembly 125 relative to the insulating housing 110, thereby facilitating sequential insertion of the terminal position assurance member 140 into the through hole HT of the insulating housing 110 and the recess GR of the isolating structure 130.

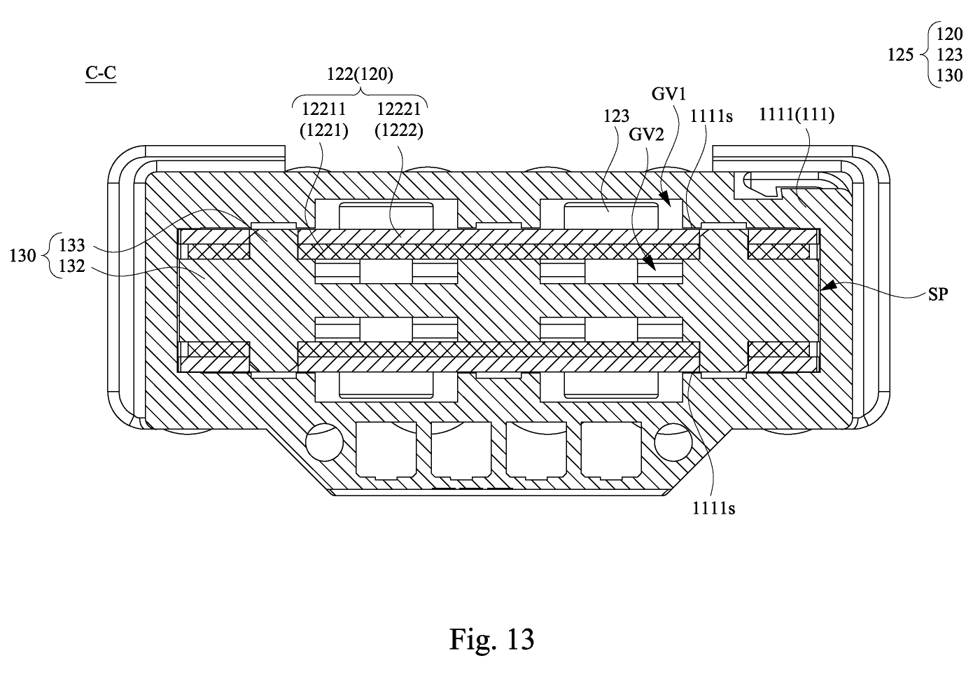

More specifically, as shown in FIG. 11 and FIG. 13, the outer shell 1111 has two opposite inner surfaces 1111s and a plurality of avoidance grooves GV1. The two inner surfaces 1111s define the space SP therebetween, and the terminal assembly 125 is at least partially located between the two inner surfaces 1111s. The inner surfaces 1111s are respectively configured to at least partially abut against the second terminal piece 1222, so as to provide a limiting function for the terminal assembly 125. The avoidance grooves GV1 are respectively recessed in the inner surfaces 1111s and are spaced apart from each other. The avoidance grooves GV1 extend in the direction in which the terminal assembly 125 is inserted into the insulating housing 110 and is communicated with the space SP. In practice, the avoidance grooves GV1 are configured to at least partially accommodate the fasteners 123 of the terminal assembly 125, and the fasteners 123 do not contact the outer shell 1111. In practical applications, as shown in FIG. 13, the locking portion 132 of the isolating structure 130 also has avoidance grooves GV2, and the avoidance grooves GV2 are likewise configured to at least partially accommodate the fasteners 123.

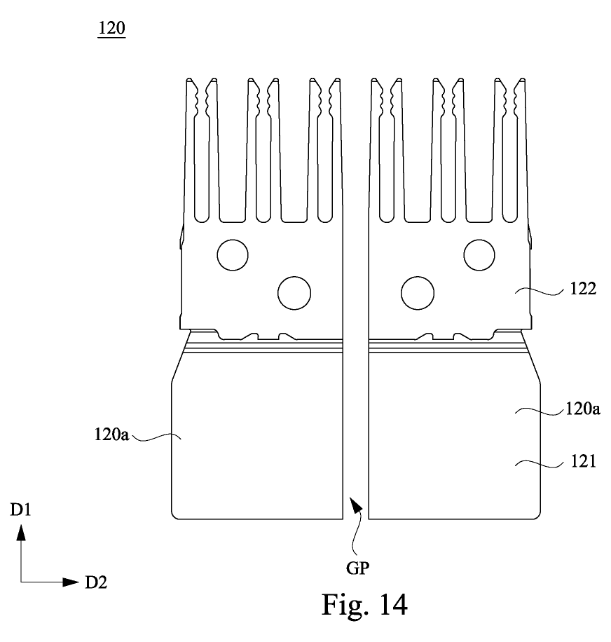

Please refer to FIG. 14. In this embodiment, the terminal 120 includes a plurality of sub-terminals 120a, and the sub-terminals 120a are spaced apart from one each other to define a gap GP therebetween, i.e., the sub-terminals 120a do not contact one another. More specifically, the wiring section 121 and the mating section 122 of the terminal 120 are arranged along a first direction D1, while the sub-terminals 120a are arranged along a second direction D2, in which the second direction D2 intersects the first direction D1. In this way, the cable-end connector 100 has greater flexibility in current distribution. For example, the first direction D1 and the second direction D2 are perpendicular to each other.

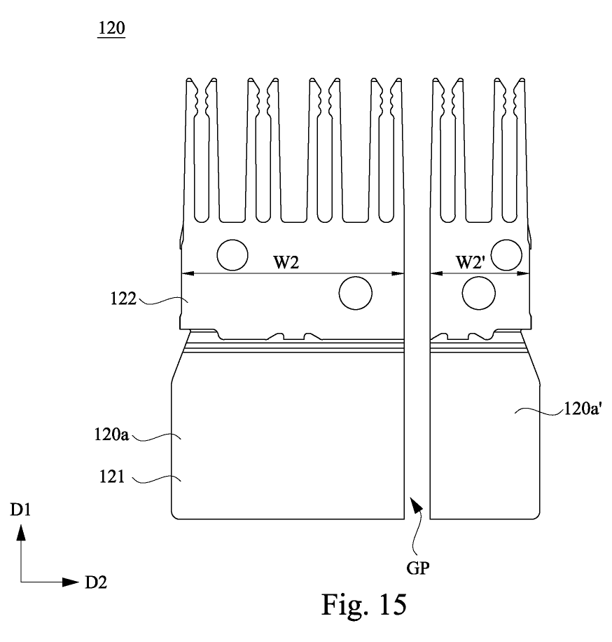

Please refer to FIG. 15. In this embodiment, each of the sub-terminals 120a has a second width W2 along the second direction D2. Depending on actual situations, the second widths W2 may be different from each other, so as to provide greater flexibility in current distribution for the cable-end connector 100. For example, as shown in FIG. 15, the second width W2 of the sub-terminal 120a is greater than the second width W2’ of the sub-terminal 120a’.

In conclusion, the aforementioned embodiments of the present disclosure have at least the following advantages: the terminal of the cable-end connector includes a wiring section and a mating section connected with the wiring section, in which the mating section is configured to electrically connect with another connector, while the wiring section is configured to connect with at least one cable (or electric wire) or busbar. Since the second thickness of the mating section is greater than the first thickness of the wiring section, even though a portion of the mating section is formed by stacking elongated conductive arms, the cross-sectional area of the terminal at the mating section can be maintained. This is advantageous for increasing the allowable current capacity of the terminal.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A cable-end connector, comprising:
an insulating housing having a first opening and a plurality of second openings opposite to the first opening;
a plurality of terminals at least partially located inside the insulating housing, each of the terminals comprising:
a wiring section at least partially exposed from the first opening, the wiring section having a first thickness; and
a mating section connected to the wiring section and at least partially exposed from the second openings, the mating section having a second thickness greater than the first thickness; and
an isolating structure sandwiched between the terminals.

2. The cable-end connector of claim 1, wherein the mating section comprises:
a first terminal piece connected with the wiring section and at least partially abutting against the isolating structure, the first terminal piece having a third thickness equal to the first thickness; and
a second terminal piece stacked on a side of the first terminal piece away from the isolating structure.

3. The cable-end connector of claim 2, wherein the first terminal piece comprises:
a first body connected to the wiring section; and
a plurality of first terminal portions respectively connected to the first body, each of the first terminal portions comprises a pair of first conductive arms at least partially exposed from a corresponding one of the second openings respectively,
the second terminal piece comprises:
a second body stacked on the first body; and
a plurality of second terminal portions respectively connected with the second body, each of the second terminal portions comprises a pair of second conductive arms aligned with and stacked on the first conductive arms, the second conductive arms are at least partially exposed from a corresponding one of the second openings respectively.

4. The cable-end connector of claim 3, wherein each of the first terminal portions further comprises at least one first protrusion located on a side of one of the first conductive arms facing to another one of the first conductive arms, each of the second terminal portions further comprises at least one second protrusion located on a side of one of the second conductive arms facing to another one of the second conductive arms.

5. The cable-end connector of claim 2, wherein the wiring section comprises:
a connecting portion abutting against the isolating structure and configured to connect with at least one wire; and
a bent portion connected between the connecting portion and the first terminal piece,
wherein the connecting portion of one of the terminals and the connecting portion of a corresponding one of the terminals define a first distance therebetween, the first terminal piece of a corresponding one of the terminals and the first terminal piece of an adjacent one of the terminals define a second distance therebetween, the first distance is smaller than the second distance.

6. The cable-end connector of claim 2, wherein the isolating structure comprises:
an isolating plate sandwiched between the wiring sections, the isolating plate has a fourth thickness; and
a locking portion connected with the isolating plate and at least partially sandwiched between the first terminal pieces, the locking portion has a fifth thickness greater than the fourth thickness.

7. The cable-end connector of claim 6, wherein the insulating housing has at least one latch groove and at least one through hole, the locking portion has at least one recess, the cable-end connector further comprises:
a terminal position assurance member comprising an insertion rod and a latch portion connected with the insertion rod, the insertion rod is configured to be sequentially inserted into the through hole and the recess, the latch portion is located outside the insulating housing and configured to latch into the latch groove.

8. The cable-end connector of claim 7, wherein the insertion rod has a first width gradually decreasing in a direction away from the latch portion.

9. The cable-end connector of claim 1, wherein the wiring section and the mating section are arranged along a first direction, at least one of the terminals comprises:
a plurality of sub-terminals arranged along a second direction, adjacent two of the sub-terminals are spaced apart from each other to define a gap therebetween, the second direction intersects the first direction.

10. The cable-end connector of claim 9, wherein each of the sub-terminals has a second width along the second direction, at least two of the second widths are different from each other.

11. A method for assembling a cable-end connector, comprising:
providing at least one first terminal element, the first terminal element comprising a wiring section, a first body and a plurality of first conductive arms, the first body being connected between the wiring section and the first conductive arms;
connecting at least one wire to the wiring section;
providing at least one second terminal element, the second terminal element comprising a connected second body and a plurality of second conductive arms connected with the second body;
stacking and fixing the second terminal element on the first terminal element to form a terminal, the second body being aligned with the first body, the second conductive arms being aligned with the first conductive arms;
connecting a plurality of the terminals formed to two opposite sides of an isolating structure respectively to form a terminal assembly;
at least partially overmolding the terminal assembly with an inner mold;
providing an insulating housing having a first opening and a plurality of second openings opposite to the first opening;
inserting the terminal assembly into the insulating housing through the first opening such that the first conductive arms and the second conductive arms are at least partially exposed from the second openings;
inserting a terminal position assurance member at least partially through the insulating housing and the isolating structure, and latching the terminal position assurance member at least partially with an outer side of the insulating housing; and
at least partially overmolding the insulating housing and the terminal assembly with an outer mold,
wherein the wiring section has a first thickness, the first conductive arms and the second conductive arms together define a second thickness greater than the first thickness.
